(19) United States
(12) Patent Application Publication
(10) Pub. No.: US 2014/0312272 A1
(43) Pub. Date: Oct. 23, 2014

(54) CARBON DIOXIDE ADSORBENT, THE MANUFACTURING METHOD THEREOF, AND THE USE METHOD THEREOF

(71) Applicant: National Chiao Tung University, Hsinchu (TW)

(72) Inventors: San-Yuan Chen, Hsinchu (TW); Fang-Yi Su, Hsinchu (TW); Po-Hsueh Chang, Hsinchu (TW)

(21) Appl. No.: 14/025,232

(22) Filed: Sep. 12, 2013

(30) Foreign Application Priority Data
Apr. 23, 2013 (TW) 102114462

(51) Int. Cl. B01J 20/04

(52) U.S. Cl. CPC B01J 20/041
USPC 252/192

(57) ABSTRACT

A method for manufacturing a carbon dioxide adsorbent is provided. The method comprises steps of providing a limestone having a first specific surface area, treating the limestone with acid solution to obtain a first substance having a second specific surface area larger than the first specific surface area, at the same time reacting the first substance with an anti-sintering agent to obtain a second substance, and calcining the second substance to obtain the carbon dioxide adsorbent containing calcium-based oxides.

The application claims the benefit of Taiwan Patent Application No. 102114462, filed on Apr. 23, 2013, in the Taiwan Intellectual Property Office, the disclosures of which are incorporated herein in their entirety by reference.

### FIELD OF THE INVENTION

The present application relates to a device for adsorbing carbon dioxide, a manufacturing method thereof and a use method thereof, particularly to a carbon dioxide adsorbent, a manufacturing method thereof and a use method thereof

### BACKGROUND OF THE INVENTION

Global warming is caused by the emission of greenhouse gases. 72% of total emitted greenhouse gases consist of carbon dioxide (CO₂). CO₂ emissions therefore are the most important cause of global warming. The production of carbon dioxide in energy generation processes is becoming more and more of a worldwide problem. The increased concentration of carbon dioxide in the atmosphere results in reduced heat radiation from the earth, which causes the temperature on earth to rise and a number of life-determining processes to be perturbed.

Furthermore, the CO₂ adsorption process plays an important and effective role in the capture of CO₂ for many industrial purposes. For example, CO₂ adsorption enhances reformation for hydrogen production, promotes CO₂ removal from flue gas and can be utilized for chemical heat pumps and energy storage systems.

Although many materials could potentially be used for CO₂ adsorption, calcium oxide (CaO) has been identified as the most feasible metal oxide candidate adsorbent for the alternating carbonation and calcination cycles due to its high CO₂ adsorption capacity, low cost and its natural abundance. Limestone is relatively abundant and cheap and thus is widely used to generate calcium oxide. Limestone is mainly composed of calcium carbonate, CaCO₃. When heated, calcium carbonate breaks down to form calcium oxide and carbon dioxide.

However, the CO₂ adsorption capacity and reversibility of CaO is reduced after several carbonation/calcination cycles, which is the most challenging problem that is imperative to solve, and thus until now, great efforts have been made to solve the problem by either reducing the rate of decay in reactivity or improving the long-term performance of adsorbents, which may be achieved by modifying the natural limestone. However, the modified natural limestone still cannot address the market requirements. Furthermore, after several carbonation/calcinations cycles, it is found that the CO₂ adsorption capacity of the modified natural limestone decreases sharply.

Therefore, because of the shortcomings of the prior art, the inventors describe a carbon dioxide adsorbent, a manufacturing method thereof and a use method thereof to effectively overcome the disadvantages of the prior art.

### SUMMARY OF THE INVENTION

A highly effective durable and much cheaper carbon dioxide adsorbent is described in the present disclosure through the treatment of natural limestone with an acidic and ion-added process.

In accordance with one aspect of the present disclosure, a method for manufacturing a carbon dioxide adsorbent is described. The method comprises steps of providing a limestone having a first specific surface area, treating the limestone with acetate to obtain a first substance having a second specific surface area larger than the first specific surface area, and next an anti-sintering agent ion precursor was subsequently added to react with the first substance to obtain a second substance and calcining the second substance to obtain the carbon dioxide adsorbent mixed oxides for high temperature CO₂ capture.

In accordance with another aspect of the present disclosure, a method for manufacturing a carbon dioxide adsorbent is described. The method comprises steps of reacting a limestone with a grain-refining solution and an anti-sintering agent to obtain a reacting substance, and heating the reacting substance to obtain the carbon dioxide adsorbent.

In accordance with a further aspect of the present disclosure, a carbon dioxide adsorbent is described. The carbon dioxide adsorbent comprises a porous structure and a plurality of anti-sintering ions distributed in the porous structure, wherein the plurality of anti-sintering ions are derived from a limestone. The porous structure contains a plurality of calcium oxide particles and a plurality of aluminium oxide particles distributed in the plurality of calcium oxide particles.

The above objectives and advantages of the present disclosure will become more readily apparent to those ordinarily skilled in the art after reviewing the following detailed descriptions and accompanying drawings, in which:

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram showing a method to manufacture a carbon dioxide adsorbent according to a first embodiment of the present disclosure.

FIG. 2 is a diagram showing another method to manufacture a carbon dioxide adsorbent according to a preferred embodiment of the present disclosure.

FIG. 3 is an X-ray diffraction pattern for intermediates and final product of the first embodiment of the present disclosure.

FIGS. 4(a) and 4(b) are diagrams showing the BET (Brunauer, Emmett and Teller) analysis and the pore size distribution of a carbon dioxide adsorbent according to a preferred embodiment of the present disclosure.

FIG. 5(a) is a scanning electronic microscope (SEM) image of a modified natural limestone according to a preferred embodiment of the present disclosure.

FIG. 5(b) is a SEM image of a calcined product of the modified natural limestone in FIG. 5(a).

FIG. 5(c) is a SEM image of natural limestone.

FIG. 5(d) is a SEM image of the calcined product of the natural limestone in FIG. 5(c).

FIG. 6(a) is a transmission electron microscope (TEM) image of modified natural limestone according to a preferred embodiment of the present disclosure.

FIG. 6(b) is a TEM image magnifying the block shown in FIG. 6(a).

FIG. 7(a) is a SEM image of modified natural limestone according to a preferred embodiment of the present disclosure.

FIG. 7(b) is a diagram showing element analysis of the modified natural limestone in FIG. 7(a).

FIG. 7(c) is a diagram showing distribution of Ca in the modified natural limestone in FIG. 7(a).

FIG. 7(d) is a diagram showing distribution of Al in the modified natural limestone in FIG. 7(a).

FIG. 8 is a diagram showing a thermal gravimetric analysis (TGA) of a carbon dioxide adsorbent according to a preferred embodiment of the present disclosure.

FIG. 9 is a diagram showing TGA of a carbon dioxide adsorbent according to a preferred embodiment of the present disclosure and a calcined product of natural limestone over 30 carbonation/calcination cycles.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

In the present disclosure, a natural limestone body is acidified by an acid solution, e.g. acetic acid, and the PH value is adjusted to increase the surface area thereof by reducing particle size and increasing the number of pores on the limestone surface. In addition, a suitable proportion of anti-sintering ions such as aluminum ion (Al³⁺), magnesium ion (Mg²⁺), zinc ion (Zn²⁺) or other anti-sintering ions may be added. After calcination at a high temperature, a carbon dioxide adsorbent that can capture CO₂ at 500-750° C. is formed. The carbon dioxide adsorbent synthesized according to the present disclosure has the properties of anti-sintering, high specific surface area, nanometer particle scale, and nanopores. In addition, it is demonstrated that the carbon dioxide adsorbent according to the present disclosure has an initial adsorption capacity in a range of 40 to 70 wt %, i.e. 0.4 to 0.7 g CO₂/g of the carbon dioxide adsorbent, and its capacity decreases only slightly after 50 cycles of carbonation and calcination, maintaining 75 to 95% of the initial adsorption capacity. Based on the carbon dioxide adsorbent, the manufacturing method thereof and the use method thereof in the present disclosure, the present invention can achieve the purposes of sustainable development of resources, energy saving and carbon reduction, which can be realized by industries such as hydrogen-producing industries and steel industries.

The concepts of the present invention are detailed as follows.

A natural limestone 101 is acidified to form a first powder. Compared with the natural limestone 101, the first powder has a smaller particle size and a larger specific surface area. The first powder is modified by adding an appropriate proportion of anti-sintering ions thereto, and thereby a carbon dioxide adsorbent with a high CO₂ adsorption capacity and high capture efficiency is generated. Further, the resulting carbon dioxide adsorbent has the properties of remaining stable and preventing deterioration particularly after repeated carbonation/calcination cycling. The main components of natural limestone include silicon oxide (SiO₂), aluminium oxide (Al₂O₃), ferric oxide (Fe₂O₃), magnesium oxide (MaO), calcium oxide (CaO), sodium oxide (Na₂O), potassium oxide (K₂O), titanium oxide (TiO₂), phosphorus oxide (P₂O₅), manganese oxide (MnO) and chromium trioxide (Cr₂O₃), and their composition proportion by weight percentage respectively are 0.49, 0.06, 0.1, 161, 54.86, 0.01, 0.02, <0.01, 0.04, 0.02 and <0.002. In addition to the above, the components of natural limestone further include copper (Cu), barium (Ba), zinc (Zn) and nickel (Ni), and the respective content is given in parts per million (ppm) as follows: <5, 21, 11 and <2. The natural limestone 101 is in a particle form and has a particle size and a specific surface area. The term “sintering” used hereafter refers to a process of heating a powdered solid material (e.g. a metal, oxide or a nitride) to a temperature below the melting point thereof to fuse the powder particles together and create one solid piece. The anti-sintering metal ion used in the present invention will be transformed into metal oxide with an anti-sintering property at a temperature, which means that the metal oxide such as Al₂O₃ will not have a series of physical or chemical reactions under that temperature to promote densification. The above temperature is ranging from 500-750° C. The anti-sintering ion may be an aluminum ion, magnesium ion, iron ion, nickel ion, barium ion, zinc ion, other metal ion, or a combination thereof. In addition, silicon may be adopted as an anti-sintering material as well.

### The First Embodiment

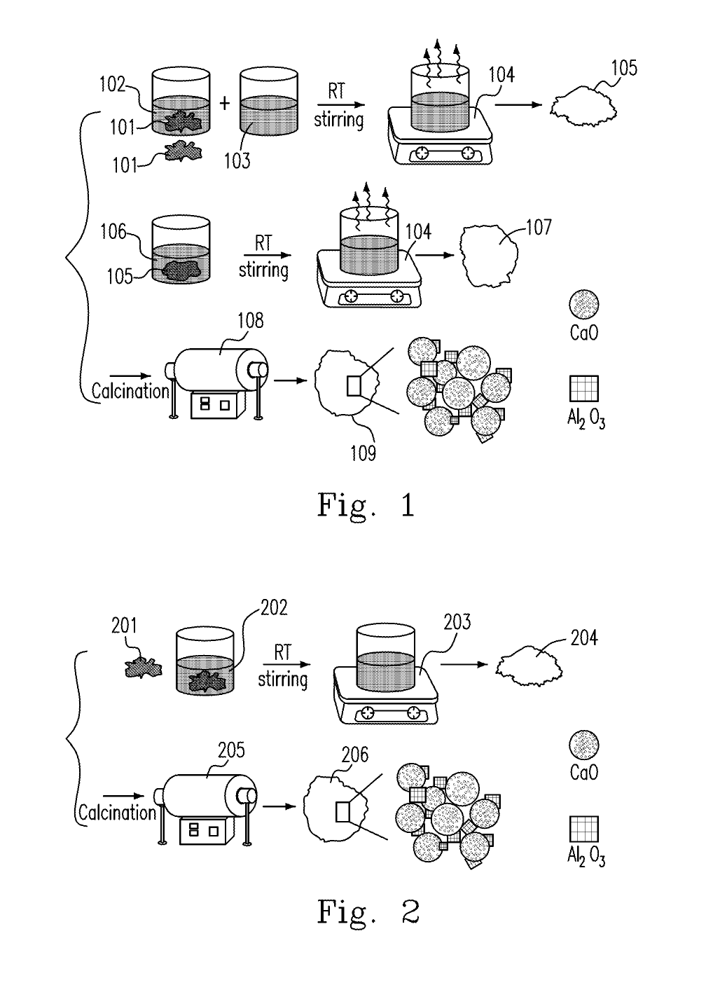

Please refer to FIG. 1, which is a diagram showing a method to manufacture a carbon dioxide adsorbent according to the first embodiment of the present disclosure. The materials and devices used in the first embodiment include natural limestone 101, deionized water 102, an acid solution 103, a heater 104, an anti-sintering agent 106 and a high temperature furnace 108.

As an example, the acid solution 103 is a 98% acetic acid solution. 1:1 by weight of 98% acetic acid solution 103 and deionized water 102 are placed in a container at normal temperature and pressure, and then natural limestone 101 is added into the container, wherein the molar ratio of the acetic acid solution 103/natural limestone 101 is 3/1. A Mole Ratio is a conversion factor that relates the amounts in moles of two or more substances involved in a chemical reaction. The mixture is stirred at room temperature (RT) for a time ranging from 1-36 hours (e.g. 12 hours) and dried at 80° C. to obtain a dry calcium acetate powder 105. The calcium acetate powder 105 is reacted with an anti-sintering agent 106 and stirred at room temperature for 12 hours. The anti-sintering agent 106 in this embodiment is a formulated technical grade Al(NO₃)₃ solution, and the mixture of the calcium acetate powder 105 and this solution has a Ca/Al weight ratio of 20/1. After the reaction, the mixture is subjected to thermal drying to obtain a Ca—Al based acid compound 107 with a porous structure. Finally, the Ca—Al based acid compound 107 is calcined in a high temperature furnace 108 at about 700° C. to obtain mixed oxides as carbon dioxide adsorbent 109 having an anti-sintering property and high CO₂-capture efficiency. The calcination reaction usually takes place at or above a thermal decomposition temperature, and in that reaction calcium carbonate is decomposed to CaO and CO₂.

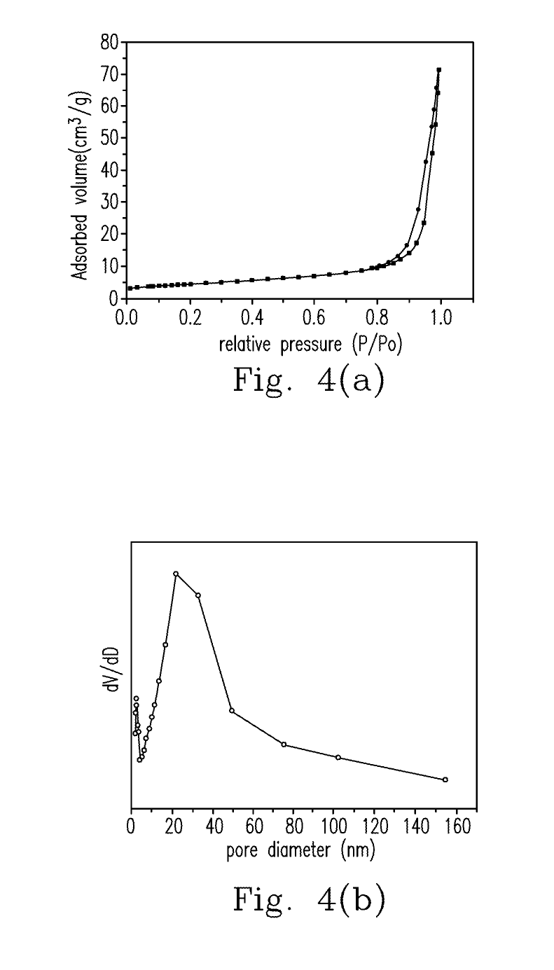

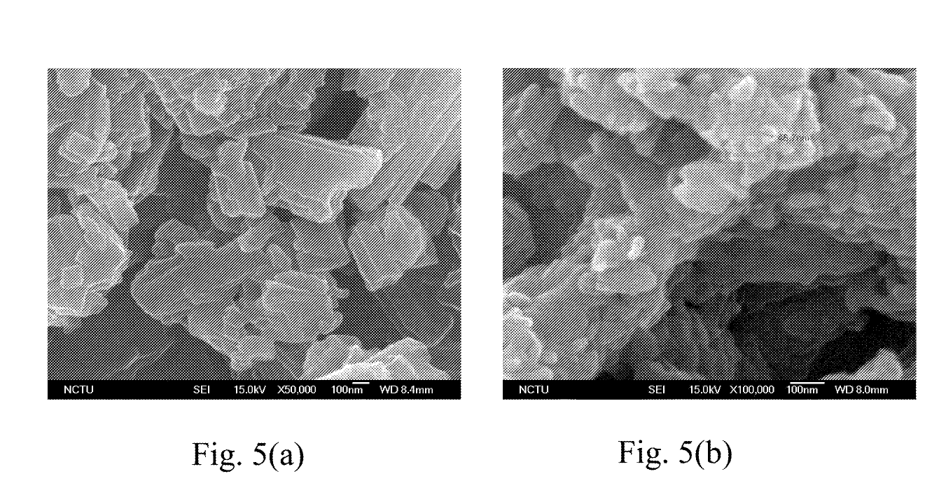

The X-ray diffraction pattern of the calcium acetate powder 105 is shown in FIG. 3, Line (a), which is a plot of diffracted intensity versus 20 (2 theta). For the calcium acetate powder 105, the X-ray diffraction peaks at 5.91, 8.09, 10.82, 12.44, 13.30, 14.36, 16.42, 21.89, 23.57, 25.78 and 27.61 degrees two-theta. The X-ray diffraction peaks are also called characteristic peaks. Compared with the data from the Joint Committee on Powder Diffraction Standards (JCPDS) NO. 39-0529 (i.e. the X-ray diffraction pattern of calcium acetate, not shown), it is found that the main characteristic peaks of the calcium acetate powder 105 in the first embodiment are consistent with those shown by the JCPDS, and thus it is demonstrated by the consistency that the natural limestone 101 has been modified to a calcium acetate powder 105 successfully. In FIG. 3, Lines (b) and (c) show the X-ray diffraction patterns of the Ca—Al based acid compounds 107 with different Ca/Al ratios, wherein the amount of Al in Line (c) is greater than that in Line (b). It is found that the signal intensity of the characteristic peak at 9.5 degrees two-theta (as shown by the arrow in FIG. 3) is enhanced with the increased amount of aluminum ions. Furthermore, when the calcium acetate powder 105 is compared with the Ca—Al based acid compounds 107 with different Ca/Al ratios via the inductively coupled plasma-optical emission spectroscopy (ICP-EA) (data not shown), it is found that the increased amount of the added aluminum ions indeed react with the calcium acetate powder 105 and cause the increase of the formed Ca—Al based acid compound 107. Compared with the original ICP-EA pattern of the calcium acetate, it is found that the characteristic peaks of the generated Ca—Al based acid compound 107 are apparently changed, which demonstrates that the aluminum ions together with the calcium acetate form the Ca—Al based acid compound 107. The Ca—Al based acid compound 107 will form a carbon dioxide adsorbent 109 majorly composed of CaO after a 700° C. heat treatment or sintering (as shown in FIG. 1). In the carbon dioxide adsorbent 109, Al₂O₃ in an amorphous-like phase is distributed in the CaO to form a carbon dioxide adsorbent 109 with a porous structure in a Ca-anti-sintering ions-O phase, which is a calcium-aluminum-oxygen (Ca-AI-O) phase in this embodiment. The X-ray diffraction pattern of the resulting carbon dioxide adsorbent 109 is shown by Line (d) in FIG. 3. After high temperature treatment, the carbon dioxide adsorbent 109 still has the porous property of its original material and is further analyzed by surface area and pore size analyzer and the BET analysis, and the results are shown in FIGS. 4(a) and (b). BET analysis provides precise specific surface area evaluation of materials by nitrogen multilayer adsorption measured as a function of relative pressure using a fully automated analyser. Via the measurement of BET, the carbon dioxide adsorbent 109 has an average pore volume of 0.11 cm³/g, a specific surface area of 15.356 m²/g and an average pore size of 28.4 nm.

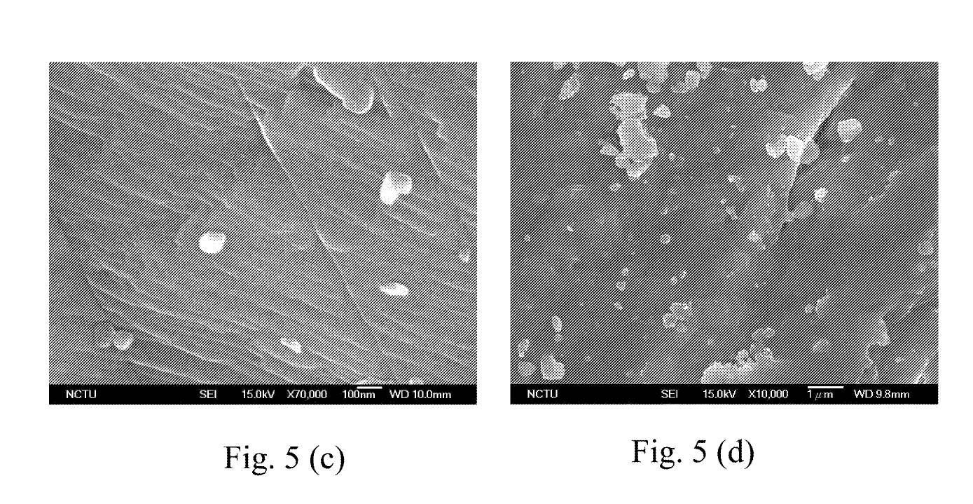

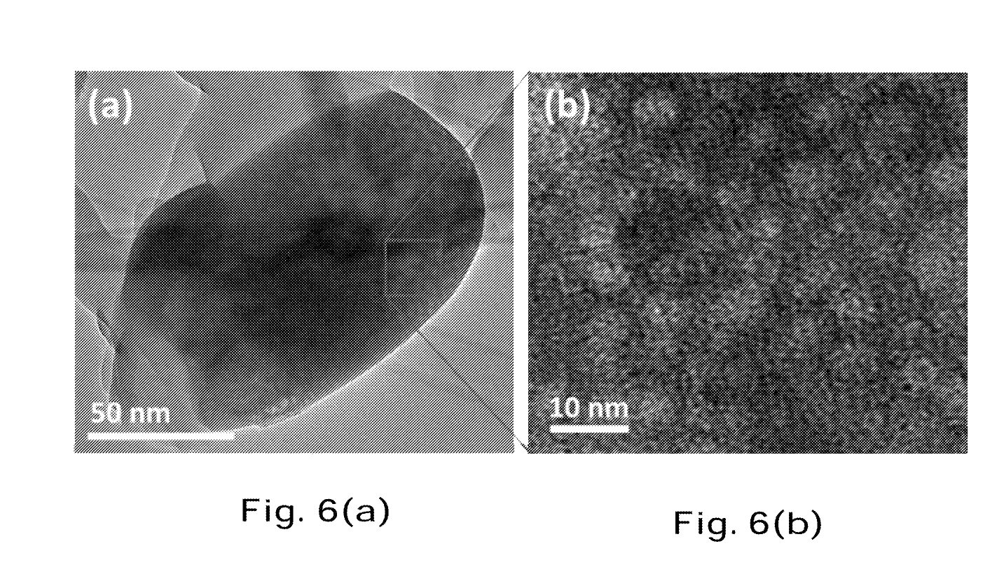

The microstructures of the modified and unmodified natural limestone and the respective calcined products thereof are observed by the scanning electronic microscope (SEM). FIGS. 5 (a) and (b) show the microstructures of the Ca—Al based acid compound 107, which is the modified natural limestone, and the calcined products thereof, i.e. the carbon dioxide adsorbent 109, in the first embodiment, respectively. FIGS. 5 (c) and (d) show the microstructures of the unmodified natural limestone and its calcined products, respectively. Compared with the natural limestone 101 with a smooth surface in FIG. 5(c) and its calcined product in FIG. 5(d), it can be seen that the modified Ca—Al based acid compound 107 in FIG. 5(a) has a particle size greatly reduced to a nanometer grade and an increased surface roughness, which means that the Ca—Al based acid compound 107 will have a specific surface area greatly larger than that of the unmodified natural limestone 101. As shown in FIG. 5(b), the microstructure of the carbon dioxide adsorbent 109 formed by a high-temperature (e.g. 700° C.) treatment reveals porous appearance and a high specific surface area, which means that the area able to react with carbon dioxide is larger than that of the natural limestone calcined at 700° C. shown in FIG. 5 (d). The microstructure of the Ca—Al based acid compound 107 of a preferred embodiment is shown in a transmission electron microscope (TEM) image in FIG. 6(a), which illustrates that the Ca—Al based acid compound 107 has a porous structure and demonstrates that the size of the Ca—Al based acid compound 107 can achieve a nanometer grade. FIG. 6(b) is a TEM image magnifying the block shown in FIG. 6(a), which also demonstrates that the Ca—Al based acid compound 107 has a nano-pore distribution.

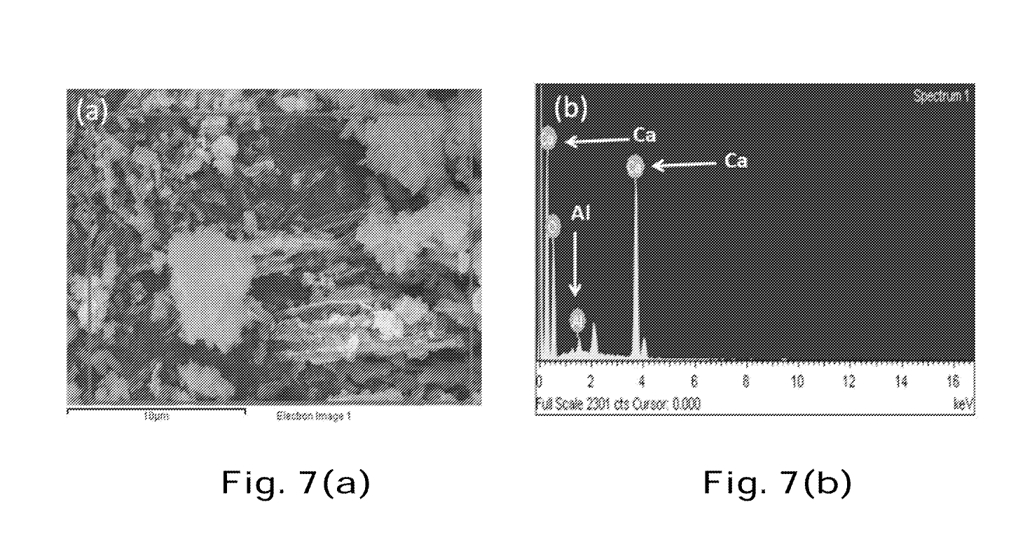

FIG. 7(a) shows an SEM image of the Ca—Al based acid compound 107 of a preferred embodiment, and its element analysis is shown in FIG. 7(b). FIG. 7(b) demonstrates that calcium ions and aluminum ions are present and the calcium ions are the major composition of that compound. Energy-dispersive X-ray spectroscopy is used to detect and map the distribution of Ca and Al in the Ca—Al based acid compound 107 of FIG. 7(a), and the results are shown in FIGS. 7(c) and (d). As shown in FIGS. 7(c) and (d), Al in the synthetic Ca—Al based acid compound 107 is uniformly distributed among the Ca-based materials. That is, by the uniform distribution of Al, the Ca-based materials in the Ca—Al based acid compound will not aggregate after the multiple carbonation/calcination cycles treatment.

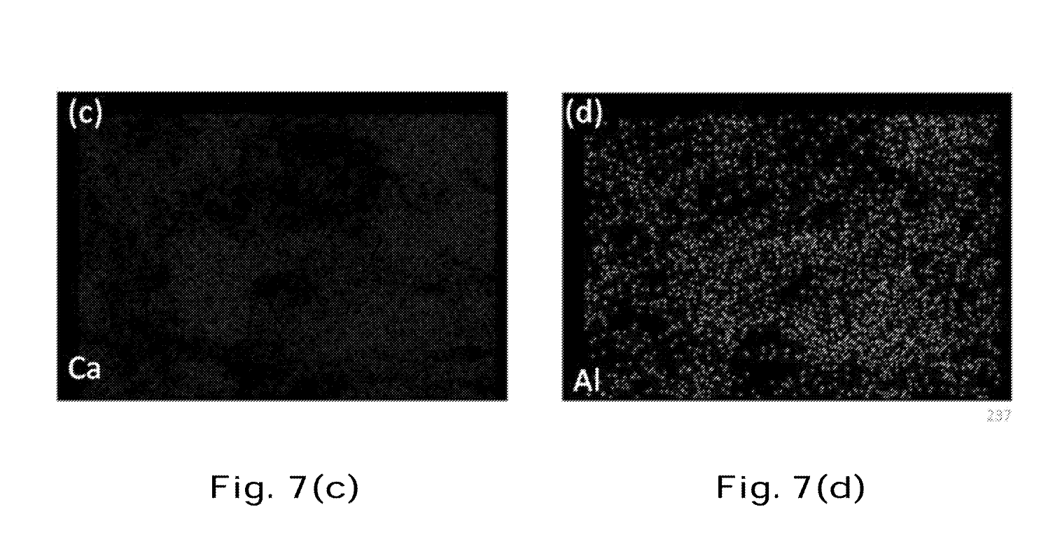

The carbon dioxide adsorbent 109 in the present disclosure has rapid adsorption capacity and high adsorption capacity because the anti-sintering aluminum ion added during the manufacturing method thereof and multiple anti-sintering ions inherently included in the natural limestone collectively prevent CaO in the carbon dioxide adsorbent 109 from aggregating together during carbonation/calcination cycles and this thus prohibits deterioration of the carbon dioxide adsorbent 109. To verify the above properties, a thermal gravimetric analyzer (TGA) is used in the present disclosure to test the CO₂-capture capacity of the carbon dioxide adsorbent 109, and the result is shown in FIG. 8. As shown in FIG. 8, the carbon dioxide adsorbent 109 can achieve the maximum CO₂-capture capacity within 1.5 minutes. This demonstrates that the carbon dioxide adsorbent 109 in the present disclosure has excellent and rapid CO₂ adsorption capacity.

### The Second Embodiment

The acid solution 103 in the first embodiment is acetic acid, but it can be replaced with lactic acid or oxalic acid. When natural limestones are acidified with various acid solutions 103 respectively, the calcium content of the obtained powders is shown in Table 1 by weight percentage. As shown in Table 1, the resultant calcium content in these experiments is similar, which implies a similar CO₂-capture capacity. That is, all of the acid solutions listed in Table 1 are applicable to the present disclosure.

TABLE 1

| acid solution | calcium content (wt %) |
|---|---|
| acetic acid | 35-39 |
| lactic acid | 34-36 |
| oxalic acid | 39-42 |

### The Third Embodiment

For the source of the anti-sintering ion, e.g. the aluminum ion, the aluminium nitrate solution in the first embodiment can be replaced with an aluminum acetate solution, and the resultant Ca/Al ratios are shown in Table 2 by weight percentage. It is demonstrated that the carbon dioxide adsorbents synthesized by using both of the anti-sintering aluminum compounds in Table as anti-sintering agents show similar CO₂-capture capacities and anti-deterioration properties.

TABLE 2

| anti-sintering aluminum | |
|---|---|
| compound | Ca/Al ratio (wt %) |
| aluminium nitrate | 19/1-21/1 |
| aluminum acetate | 20/1-23/1 |

### The Fourth Embodiment

The relations between the acetic acid/natural limestone molar ratios and the corresponding content of calcium acetate are shown in Table 3. It can be known from Table 3 that when the acetic acid/natural limestone molar ratio is higher than 3/1, the content of the formed calcium acetate can be maintained at a relative high level, i.e. about 33-40%. That is, when the acetic acid/natural limestone molar ratio is higher than 3/1, the resultant carbon dioxide adsorbent will have a relative high ratio of CaO, which will result in a relatively high adsorbed amount of CO₂ as well as the anti-deterioration property.

TABLE 3

| acetic acid/limestone (molar ratio) | calcium acetate content (wt %) |
|---|---|
| 1/1 | 20-23 |
| 3/1 | 30-35 |
| 5/1 | 32-36 |
| 7/1 | 36-41 |
| 10/1 | 37-42 |

### The Fifth Embodiment

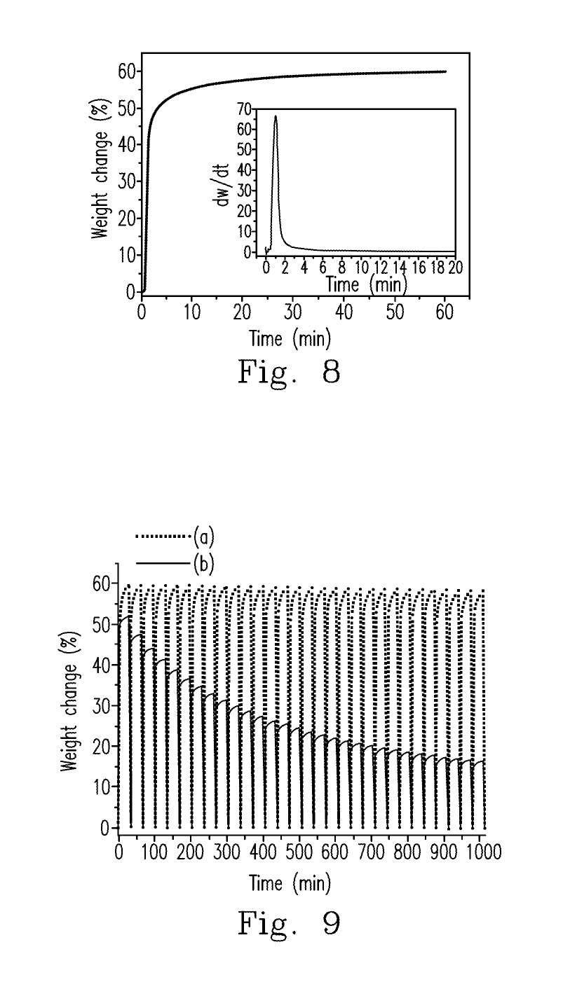

The effect of various Ca/Al ratios of the Ca—Al based acid compound 107 in CO₂ adsorption performance of carbon dioxide adsorbents is analyzed by thermal gravimetric analysis (TGA) and the results are shown in Table 4 and FIG. 8. The TGA is conducted at an experimental temperature of 700° C. for a reaction time of 60 minutes under a pure CO₂ atmosphere or a CO₂-containing mixture gas. As shown in FIG. 8, in which dw/dt is the weight loss with respect to time and means the CO₂ adsorption amount with respect to time, the tested carbon dioxide adsorbent can achieve a maximum CO₂ adsorption within 1.5 min. The data in Table 4 is obtained from TGA plots of carbon dioxide adsorbents with different Ca/Al ratios, and as shown, the Ca/Al ratios are proportional to the CO₂ adsorption capacity. Specifically, when the Ca/Al ratio increases from 7/1 to 20/1, the CO₂ adsorption capacity correspondingly increases from 43.2 wt % to about 60 wt %. Although carbon dioxide adsorbents with different Ca/Al ratios would have different CO₂ adsorption capacities, it is verified by using the TGA method that the carbon dioxide adsorbents with all ratios disclosed in the present invention have relative high CO₂ adsorption capacities and the property of anti-deterioration. FIG. 9 shows the CO₂ adsorption performance of a carbon dioxide adsorbent in the present application (a) and a carbon dioxide adsorbent obtained from calcination of natural limestone at 700° C. (b) through 30 CO₂-capture-and-release cycles by using TGA. The CO₂-capture process, i.e. the carbonation process, is conducted at a first temperature under a first environment for a first reaction time, wherein the first temperature is 700° C., the first reaction time is 25 min and the first environment includes a gas at least containing CO₂. The CO₂-release process, i.e. the calcination process, is conducted at a second temperature under a second environment for a second reaction time, wherein the second temperature is 700° C., the second reaction time is 8 minutes and the second environment includes a gas at least containing N₂. Particularly, FIG. 9 shows the decrease in the CO₂ adsorption performance of the calcined natural limestone upon cycling, and in contrast, the carbon dioxide adsorbent in the present application can achieve effective CO₂ capture over a least 30 cycles with almost no deterioration. Generally, the commercial carbon dioxide adsorbents have to perform carbonation at a first temperature and calcination at a temperature higher than the first temperature. By contrast, for the carbon dioxide adsorbents in the present disclosure, the carbonation/calcination cycles can be performed at the same temperature without causing a decay in reactivity.

TABLE 4

| Ca/Al ratios(wt %) | CO₂ adsorption capacity (wt %) |
|---|---|
| 7/1 | 43.2 |
| 13/1 | 54.3 |
| 20/1 | 60.1 |

### The Sixth Embodiment

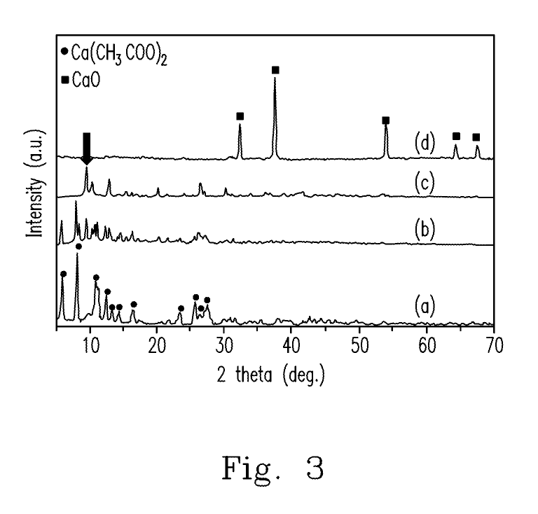

Please refer to FIG. 2. Compared with the process shown in the first embodiment, a one-pot process is used in this embodiment to synthesize a carbon dioxide adsorbent 206. The materials and devices used in this embodiment include natural limestone 201, a mixed solution 202, a heater 203 and a high temperature furnace 205. Initially, the natural limestone 201 is reacted with a mixed solution 202 including an acid solution, deionized water and an anti-sintering-Al compound under normal temperature and pressure for 1-36 hours (e.g. 12 hours). As an example, the acid solution is an acetic acid solution, the anti-sintering-Al compound is aluminium nitrate and the ratio of acetic acid/deionized water/natural limestone 201/aluminium nitrate is 10/18/20/2 by weight percentage. The mixture is heated by the heater 203 and dried to obtain a Ca—Al based acid compound 204. The Ca—Al based acid compound 204 is calcined in a high temperature furnace 205 to obtain a carbon dioxide adsorbent 206 having a porous structure in a Ca—Al—O phase, an anti-sintering property and high capture efficiency. The heaters 104, 203 in the present disclosure may be an oven, a heating plate or any heating device.

Specific surface area “SSA” is a property of solids which is the total surface area of a material per unit of mass, solid or bulk volume, or cross-sectional area. It is a derived scientific value that can be used to determine the type and properties of a material. It is defined either by surface area divided by mass (with the unit of m²/kg), or surface area divided by the volume (with the unit of m²/m³ or m⁻¹).

In each embodiment, the natural limestone has a first total surface area, a first total mass and a first specific surface area that is defined by the first total surface area divided by the first total mass. The natural limestone may include at least one natural limestone particle, but it is not limited thereto. In each embodiment, the Ca—Al based acid compound 107, 204 has a second total surface area, a second total mass and a second specific surface area that is defined by the second total surface area divided by the second total mass. The second specific surface area is greater than the first specific surface area.

In a preferred embodiment, a fixed weight ratio of acetic acid/deionized water/limestone/aluminium nitrate is applied to different processes disclosed in the present disclosure, and it is found when the remaining variant factor, i.e. the reaction time, exceeds 5 hours (as shown in Table 5), the reactant in each process can be reacted completely and thus a carbon dioxide adsorbent with excellent and rapid CO₂ adsorption capacity, high CO₂ adsorption performance and anti-deterioration property can be obtained. The weight ratio of acetic acid/deionized water/limestone/aluminium nitrate in Table 5 is fixed at 10/18/20/2.

TABLE 5

| | CO₂ adsorption | CO₂ adsorption capacity |
|---|---|---|
| Reaction time (hr) | capacity (wt %) | after 30 cycles (wt %) |
| 1 | 58.9 | 40.2 |
| 3 | 59.8 | 50.3 |
| 5 | 60.1 | 58.5 |
| 12 | 61.9 | 59.8 |
| 36 | 62.4 | 60.1 |

Although natural minerals and commercial calcium oxide have a high conversion rate of carbonation, after a number of carbonation and calcination cycles, their CO₂ adsorption capacity deteriorates rapidly with time because of the reduced specific surface area (equivalent to the reduced CO₂ adsorption amount) caused by the powder aggregation during high-temperature calcination. The carbon dioxide adsorbents provided in the present disclosure not only have the increased reaction area by acidification, but also the property of anti-deterioration caused by the addition of some aluminum ions to inhibit the aggregation of CaO.

Some embodiments of the present disclosure are described in the following.

1. A method for manufacturing a carbon dioxide adsorbent is described. The method comprises steps of providing a limestone having a first specific surface area, treating the limestone to obtain a first substance having a second specific surface area larger than the first specific surface area, reacting the first substance with an anti-sintering agent to obtain a second substance, and calcining the second substance to obtain the carbon dioxide adsorbent.

2. A method of Embodiment 1, wherein the limestone has a first total surface area and a first total mass, the first substance has a second total surface area and a second total mass, the first specific surface area is obtained by dividing the first total surface area by the first total mass, and the second specific surface area is obtained by dividing the second total surface area by the second total mass.

3. A method of any of the previous embodiments further comprises steps of conducting the carbon dioxide adsorbent to a carbonation process at a temperature to obtain an intermediate, and calcining the intermediate at the temperature to recover the carbon dioxide adsorbent.

4. A method of any of the previous embodiments, wherein the limestone is treated with an acid solution for a time ranging from 1-36 hours to obtain the first substance.

5. A method of any of the previous embodiments, wherein the acid solution to the limestone has a molar ratio ranging from 1-10.

6. A method of any of the previous embodiments, wherein the acid solution includes an acid being one selected from a group consisting of an acetic acid, an oxalic acid, a lactic acid and a combination thereof.

7. A method of any of the previous embodiments, wherein the anti-sintering agent includes an anti-sintering ion.

8. A method of any of the previous embodiments, wherein the anti-sintering agent is one selected from a group consisting of an aluminum nitrate, an aluminum acetate and a combination thereof.

9. A method of any of the previous embodiments, wherein the second substance is an anti-sintering ionic compound containing a calcium.

10. A method of any of the previous embodiments, wherein the carbon dioxide adsorbent includes a calcium and an aluminium with a weight ratio of the calcium to the aluminium ranging from 3-20.

11. A method for manufacturing a carbon dioxide adsorbent is provided, the method comprises steps of reacting a limestone with a grain-refining solution and an anti-sintering agent to obtain a reacting substance, and heating the reacting substance to obtain the carbon dioxide adsorbent.

12. A method of Embodiment 11, wherein the grain-refining solution is an acid solution, which includes an acid being one selected from a group consisting of an acetic acid, an oxalic acid, a lactic acid and a combination thereof.

13. A method of any of the previous embodiments, wherein the anti-sintering agent includes an aluminium ion.

14. A method of any of the previous embodiments, wherein the reaction is performed at a normal pressure and temperature for a duration ranging from 1-36 hours.

15. A carbon dioxide adsorbent is provided. The carbon dioxide adsorbent comprises a porous structure and a plurality of anti-sintering ions distributed in the porous structure, wherein the plurality of anti-sintering ions are derived from a limestone. The porous structure contains a plurality of calcium oxide particles and a plurality of aluminium oxide particles distributed in the plurality of calcium oxide particles.

16. A carbon dioxide adsorbent of Embodiment 15, wherein the plurality of anti-sintering ions include an ion being one selected from a group consisting of an aluminum ion, a magnesium ion, a sodium ion, an iron ion, a nickel ion, a barium ion, a zinc ion and a combination thereof.

17. A carbon dioxide adsorbent of any of the previous embodiments, further comprising a silica distributed in the porous structure.

18. A carbon dioxide adsorbent of any of the previous embodiments, wherein the plurality of aluminium oxide particles are a plurality of amorphous aluminium oxide particles.

19. A carbon dioxide adsorbent of any of the previous embodiments, wherein the carbon dioxide adsorbent has a first CO₂ adsorption capacity in a range of 0.4-0.7 g CO₂/g of the carbon dioxide adsorbent.

20. A carbon dioxide adsorbent of any of the previous embodiments, wherein the carbon dioxide adsorbent has a second CO₂ adsorption capacity after 50 cycles of a carbonation and calcination process, and the second CO₂ adsorption capacity is 75-95% of the first CO₂ adsorption capacity.

While the disclosure has been described in terms of what is presently considered to be the most practical and preferred embodiments, it is to be understood that the disclosure needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing a carbon dioxide adsorbent, comprising:
providing a limestone having a first specific surface area;
treating the limestone to obtain a first substance having a second specific surface area larger than the first specific surface area;
reacting the first substance with an anti-sintering agent to obtain a second substance; and
calcining the second substance to obtain the carbon dioxide adsorbent.

2. A method as claimed in claim 1, wherein the limestone has a first total surface area and a first total mass, the first substance has a second total surface area and a second total mass, the first specific surface area is obtained by dividing the first total surface area by the first total mass, and the second specific surface area is obtained by dividing the second total surface area by the second total mass.

3. A method as claimed in claim 1, further comprising:
conducting the carbon dioxide adsorbent to a carbonation process at a temperature to obtain an intermediate; and
calcining the intermediate at the temperature to recover the carbon dioxide adsorbent.

4. A method as claimed in claim 1, wherein the limestone is treated with an acid solution for a time ranging from 1-36 hours to obtain the first substance.

5. A method as claimed in claim 4, wherein the acid solution to the limestone has a molar ratio ranging from 1-10.

6. A method as claimed in claim 4, wherein the acid solution includes an acid being one selected from a group consisting of an acetic acid, an oxalic acid, a lactic acid and a combination thereof.

7. A method as claimed in claim 1, wherein the anti-sintering agent includes an anti-sintering ion.

8. A method as claimed in claim 1, wherein the anti-sintering agent is an anti-sintering ion precursor.

9. A method as claimed in claim 1, wherein the anti-sintering agent is one selected from a group consisting of an aluminum nitrate, an aluminum acetate and a combination thereof.

10. A method as claimed in claim 1, wherein the second substance is an anti-sintering ionic compound containing a calcium.

11. A method as claimed in claim 1, wherein the carbon dioxide adsorbent includes a calcium-based oxide.

12. A method as claimed in claim 1, wherein the carbon dioxide adsorbent includes a calcium and an aluminium with a weight ratio of the calcium to the aluminium ranging from 3-20.

13. A method for manufacturing a carbon dioxide adsorbent, comprising:
reacting a limestone with a grain-refining solution and an anti-sintering agent to obtain a reacting substance; and
heating the reacting substance to obtain the carbon dioxide adsorbent, wherein the carbon dioxide adsorbent has a first CO₂ adsorption capacity in a range of 0.4 to 0.7 g CO₂/g of the carbon dioxide adsorbent and has a second CO₂ adsorption capacity after 50 cycles of a carbonation and calcination process, and the second CO₂ adsorption capacity is 75-93% of the first CO₂ adsorption capacity.

14. A method as claimed in claim 13, wherein the grain-refining solution is an acid solution, which includes an acid being one selected from a group consisting of an acetic acid, an oxalic acid, a lactic acid and a combination thereof.

15. A method as claimed in claim 13, wherein the anti-sintering agent includes an aluminium ion.

16. A method as claimed in claim 13, wherein the reaction is performed at a normal pressure and temperature for a duration ranging from 1-36 hours.

17. A carbon dioxide adsorbent, comprising:
a porous structure containing a plurality of calcium oxide particles and a plurality of aluminium oxide particles distributed in the plurality of calcium oxide particles; and
a plurality of anti-sintering ions distributed in the porous structure, wherein the plurality of anti-sintering ions are derived from a limestone.

18. A carbon dioxide adsorbent as claimed in claim 17, wherein the plurality of anti-sintering ions include an ion being one selected from a group consisting of an aluminum ion, a magnesium ion, an iron ion, a nickel ion, a zinc ion and a combination thereof.

19. A carbon dioxide adsorbent as claimed in claim 17, wherein the carbon dioxide adsorbent has a first CO₂ adsorption capacity in a range of 0.4-0.7 g CO₂/g of the carbon dioxide adsorbent.

20. A carbon dioxide adsorbent as claimed in claim 19, wherein the carbon dioxide adsorbent has a second CO₂ adsorption capacity after 50 cycles of a carbonation and calcination process, and the second CO₂ adsorption capacity is 75-95% of the first CO₂ adsorption capacity.
